(19) United States
(12) Patent Application Publication
(10) Pub. No.: US 2019/0209277 A1
(43) Pub. Date: Jul. 11, 2019

(54) DENTAL CLEANING TOOL INCLUDING PIVOTABLE BRUSH

(71) Applicant: WORLD WIDE DAILY HOLDING COMPANY LIMITED, Kwai Chung, N.T. Hong Kong (CN)

(72) Inventor: Chun Yuen TO, Hong Kong (CN)

(73) Assignee: World Wide Daily Holdings Company Limited, Kwai Chung, N.T. Hong Kong (CN)

(21) Appl. No.: 15/558,858

(22) PCT Filed: Sep. 9, 2016
(86) PCT No.: PCT/CN2016/098559

§ 371 Date: Sep. 15, 2017

(51) Int. Cl. A61C 15/04; A46B 15/00; A46B 5/00

(52) U.S. Cl. CPC A61C 15/046; A61C 15/02; A46B 5/0066; A46B 15/0055

(57) ABSTRACT

A dental cleaning tool includes a handle defining a longitudinal axis of the tool, a floss holder a floss holder having a base and two arms extending from the base in perpendicular relation to the longitudinal axis, at least one strand of floss extending between the two arms, and a pivotable brush attached to the floss holder. The pivotable brush includes a rod and bristles disposed on the rod. The rod is pivotably mounted to the floss holder between a first, stowed position and a second, use position.

### FIELD

The field of this disclosure relates generally to dental cleaning tools, and more specifically, to a dental cleaning tool including a pivotable brush.

### BACKGROUND

Dental cleaning tools are used to remove food remnants and/or build-up from the surface of or between teeth. As a result, some known dental cleaning tools include a brush for cleaning the surface of teeth and other known dental cleaning tools include floss and/or a pick for removing or loosening food remnants (or other debris) lodged between adjacent teeth. However, often known dental cleaning tools can be difficult for a user to manipulate because the dental cleaning tool has to be at least partially inserted inside the user's mouth. Moreover, the user has to hold the dental cleaning tool awkwardly to reach and clean teeth located in the back of the mouth. Thus, known dental cleaning tools are difficult to use on or between teeth located in or near the back of the mouth. In additional, the user often has to switch between discrete tools (e.g., a brush, floss, and/or a pick) to realize the various benefits of each of these tools.

Some conventional dental cleaning tools include combinations of floss, a pick, and/or a brush, which often exacerbates the difficulty of using the dental cleaning tool. For example, the user may have to hold and manipulate the dental cleaning tool in a manner that is uncomfortable to hold or have inserted into ones mouth. Additionally, the floss, pick, and/or brush may obstruct use of the other components of the dental cleaning tool. For example, the floss, pick, or brush may be attached such that the user has difficulty positioning other portions of the dental cleaning tool inside the user's mouth. As a result, some users may skip or ineffectively clean portions of their teeth to avoid discomfort.

Accordingly, there is a need for an improved dental cleaning tool that combines a number of cleaning components and is comfortable to use in an easy and effective manner.

### BRIEF DESCRIPTION

In one aspect, a dental cleaning tool generally comprises a handle defining a longitudinal axis of the tool, a floss holder a floss holder having a base and two arms extending from the base in perpendicular relation to the longitudinal axis, at least one strand of floss extending between the two arms, and a pivotable brush attached to the floss holder. The pivotable brush includes a rod and bristles disposed on the rod, and the rod is pivotably mounted to the floss holder between a first, stowed position and a second, use position.

In another aspect, a dental cleaning tool generally comprises a handle defining a longitudinal axis of the tool, a floss holder for holding a plurality of floss strands, a pivotable brush attached to the floss holder, and a toothpick having a pointed tip. The pivotable brush includes a rod and bristles extending from the rod, and the rod is pivotably mounted to the floss holder. The toothpick is spaced from the floss holder such that the handle is disposed between the toothpick and the floss holder.

In a further aspect, a method of using a dental cleaning tool is provided. The dental cleaning tool includes a handle, a floss holder for holding a plurality of floss strands, a pivotable brush attached to the floss holder, wherein the pivotable brush includes a rod and bristles extending from the rod, the rod pivotably mounted to the floss holder, and a toothpick having a pointed tip. The method generally comprises selectively pivoting the pivotable brush between a first, stowed position parallel to a portion of the floss holder and a second, use position angled relative to the portion of the floss holder. The method also includes using the pivotable brush to brush at least one tooth while the pivotable brush is in one of the first position and the second position.

### BRIEF DESCRIPTION OF THE DRAWINGS

FIG. 1 is a perspective of one suitable embodiment of a dental cleaning tool including a pivotable brush.

FIG. 2 is a right side elevation of the dental cleaning tool showing the pivotable brush in multiple positions.

FIG. 3 is a front elevation of the dental cleaning tool.

FIG. 4 is a top elevation of the dental cleaning tool.

FIG. 5 is an exploded perspective of the dental cleaning tool.

### DETAILED DESCRIPTION OF THE DRAWINGS

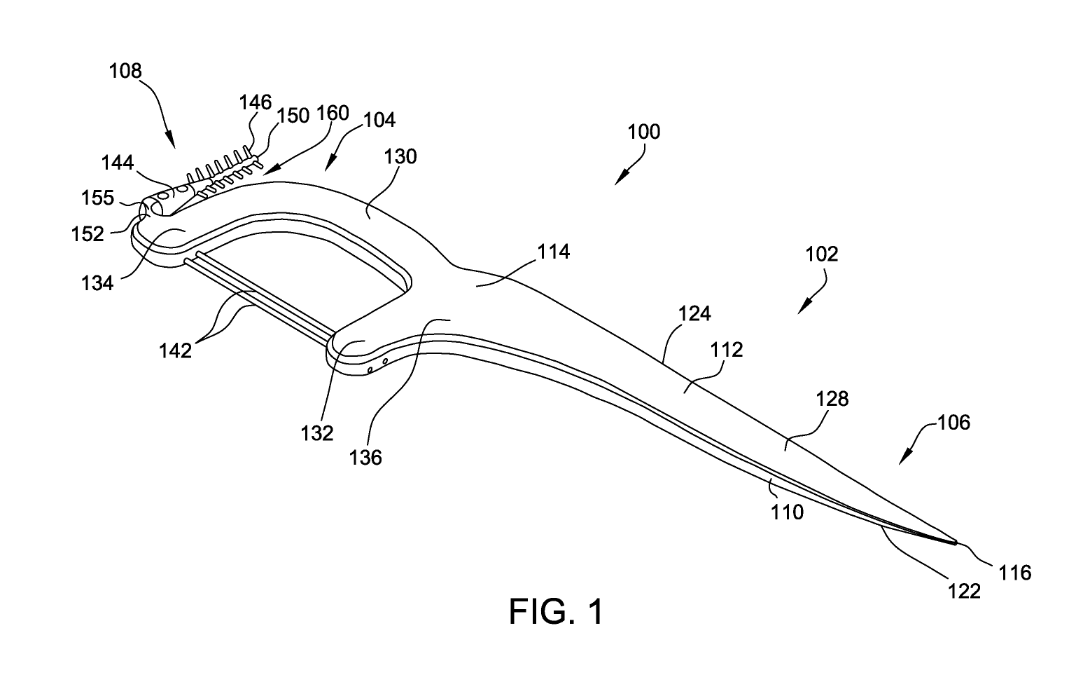

FIGS. 1-5 illustrate one suitable embodiment of a dental cleaning tool, indicated generally at 100. As seen therein, the illustrated dental cleaning tool 100 includes a handle 102, a floss holder 104, a toothpick 106, and a pivotable brush 108. The handle 102, the floss holder 104, the toothpick 106, and the pivotable brush 108 are each indicated generally by their respective reference number in the accompanying figures. It is understood that in some other suitable embodiments that do not depart from some of the aspects of this invention, the dental cleaning tool 100 may include any combination(s) of the floss holder 104, the toothpick 106, and/or the pivotable brush 108. In the illustrated embodiment, a ridge 110 extends about the perimeter of the dental cleaning tool 100 to provide additional strength to the dental cleaning tool 100 and facilitate a user gripping the dental cleaning tool 100.

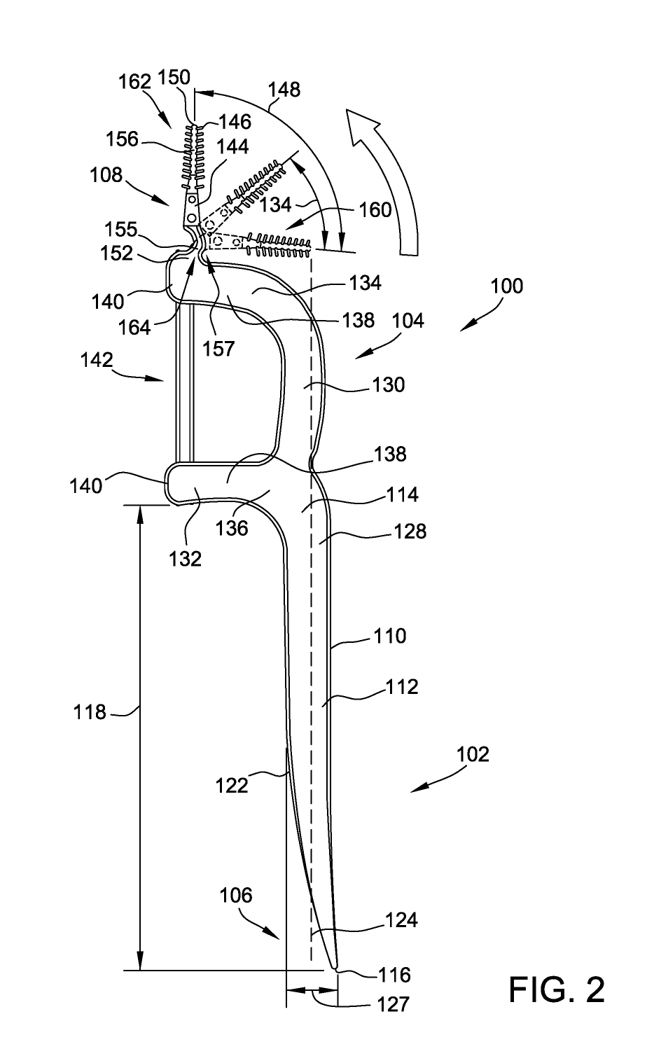

As illustrated in FIG. 2, the handle 102 includes a grip portion 112, a floss end 114, and a pick end 116. In the illustrated embodiment, the handle 102 has a length 118 measured between the floss end 114 and the pick end 116 along a longitudinal axis 120 of the dental cleaning tool 100, which extends through the handle 102. In suitable embodiments, the length 118 of the handle 102 may be any measurement that enables the dental cleaning tool 100 to function as described herein. Suitably, the length 118 is in the range between about 43 mm and about 52 mm. In the illustrated embodiment, for example, the length 118 of the handle 102 is approximately 48 mm.

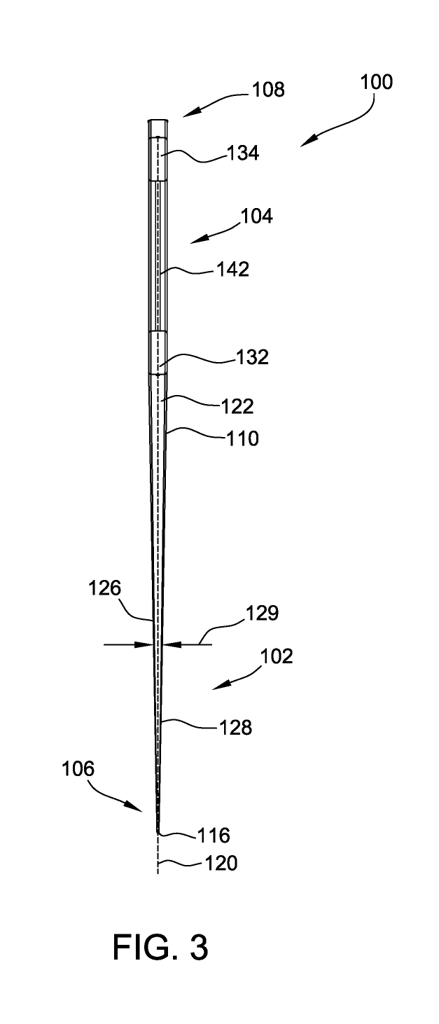

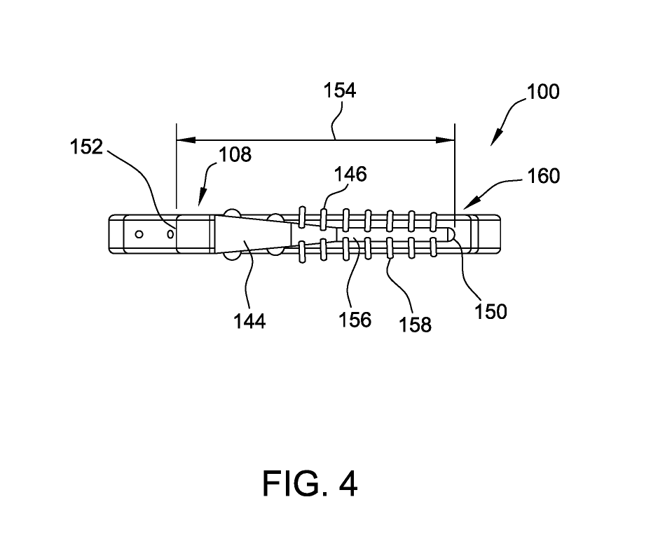

In the illustrated embodiment and as best seen in FIGS. 2-4, the handle 102 includes a front wall 122, an opposing rear wall 124, a first side wall 126, and a second side wall 128 opposite the first side wall. As illustrated in FIG. 4, the side walls 126, 128 are oriented perpendicularly to and connect the front and rear walls 122, 124. A width 127 (FIG. 2) is measured between the front wall 122 and the rear wall 124 and a thickness 129 (FIG. 3) is measured between the two side walls 126, 128. Suitably, the width 127 of the handle 102 is in the range between about 3.8 mm and about 5.8 mm. In the illustrated embodiment, for example, the width 127 is approximately 4.8 mm. Suitably, the thickness 129 of the handle 102 is in the range between about 1.5 mm and about 2.8 mm. In the illustrated embodiment, for example, the thickness 129 is approximately 1.9 mm.

The toothpick 106, which defines a distal end portion of the handle 102 and, more specifically, defines the pick end 116 of the handle, facilitates removing and/or loosening debris such as food remnants from between the user's teeth. It is contemplated that the toothpick 106 can have any suitable shape that facilitates the removal of debris between adjacent teeth. In the illustrated embodiment, the pick end 116 of the handle 102 is pointed to define the toothpick 106. Specifically, the width of at least of the side walls 126, 128 tapers to a point towards the pick end 116. In the illustrated embodiment, as best seen in FIG. 3, both the first side wall 126 and the second side wall 128 taper towards the pick end 116. As a result, the front wall 122 and the rear wall 124 meet at the pick end 116. It is understood that only one of the side walls 126, 128 could taper. For example, in one alternative embodiment, only the second side wall 128 could taper and, in such an embodiment, the first side wall 126 would be generally planar.

In the illustrated embodiment, the toothpick 106 is formed as a single piece with the handle 102. In other words, the toothpick 106 is an integral extension of the handle 102. It is understood, however, that the toothpick 106 can be formed as a separate component and attached to the handle 102 during assembly of the dental cleaning tool 100. It is also contemplated that the toothpick 106 can be removably attached to the dental cleaning tool 100 in other suitable embodiments without departing from some aspects of this invention.

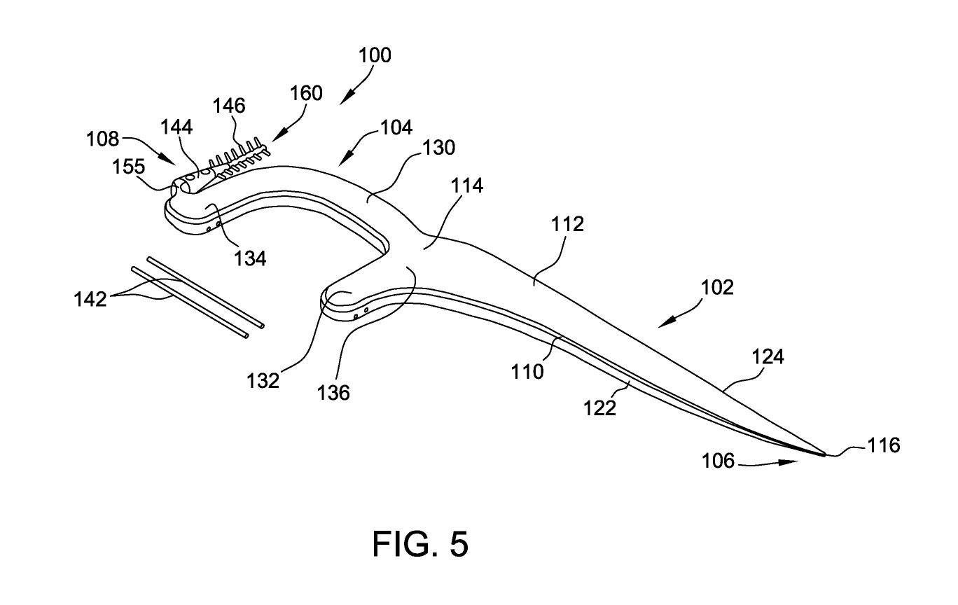

In the illustrated embodiment, the floss holder 104 extends from the floss end 114 of the handle 102. The floss holder 104 includes an arcuate (or broadly, nonlinear) base 130 and two arms (an inner arm 132 and an outer arm 134) extending in spaced relationship from each other from the base. As seen in FIGS. 2 and 5, the inner arm 132 and the outer arm 134 are substantially parallel relative to each other. The floss holder 104 in the illustrated embodiment is generally U-shaped. However, it is understood that in other suitable embodiments, the floss holder 104 may have any suitable shape.

In the illustrated embodiment, the floss holder 104 is formed as a single-piece with the handle 102. In other words, the floss holder 104 is an integral extension of the handle 102. It is understood, however, that the floss holder 104 can be formed as a separate component and attached to the handle 102 during assembly of the dental cleaning tool 100.

With reference still to FIGS. 2 and 5, the dental cleaning tool 100 includes a curved portion 136 extending between the handle 102 and the floss holder 104. As a result, in the illustrated embodiment, a majority of the base 130 of the floss holder 104 is disposed below the longitudinal axis 120 of the dental cleaning tool 100. The curved portion 136 facilitates the user gripping the handle 102 and positioning the floss holder 104 in the user's mouth. It is understood that the floss holder 104 can be oriented in any manner in relation to the handle 102 that enables the floss holder 104 to function as described herein. For example, the curved portion 136 can be omitted in some suitable embodiments. In such embodiments, the base 130 of the floss holder 104 would be aligned with the longitudinal axis 120 of the dental cleaning tool 100.

Each of the inner and outer arms 132, 134, which are cantilevered with respect to base 130, includes a proximal portion 138 and a distal portion 140. The proximal portions 138 are connected to the base 130 and the distal portions 140 are spaced from the base 130. At least one floss strand 142 extends between the distal portions 140 of the inner and outer arms 132, 134. For example, in the illustrated embodiment, two floss strands 142 extend between the inner and outer arms 132, 134. Suitably, the floss strands 142 are substantially parallel to each other. It is understood that the floss holder 104 may have any suitable configuration without departing from some aspects of this disclosure. For example, the floss strands 142 may be selectively removable from the inner and outer arms 132, 134 such that the user can manually remove and/or replace the floss strands 142.

In one suitable embodiment, the pivotable brush 108 extends from the floss holder 104. Suitably, the pivotable brush 108 extends from one of the inner and outer arms 132, 134. In the illustrated embodiment, the pivotable brush 108 extends from the outer arm 134 (i.e., the arm spaced the furthest from the handle 102). It is understood, however, that the pivotable brush 108 may extend from any portion of the dental cleaning tool 100 in other suitable embodiments without departing from some aspects of this invention.

With reference to FIGS. 1, 2, and 5, the pivotable brush includes a rod 144 and a plurality of bristles 146 extending from the rod 144. More generally, the pivotable brush 108 is pivotably mounted to and extends from the floss holder 104. More specifically, the pivotable brush 108 is pivotably mounted to and extends from the outer arm 134. In the illustrated embodiment, the pivotable brush 108 extends beyond the transverse extent of the floss holder 104. That is, the pivotable brush 108 extends transversely along the longitudinal axis 120 a greater distance than the base 130 of the floss holder 104. As seen in FIG. 2, the illustrated pivotable brush 108 is disposed, in its entirety, below the longitudinal axis 120.

The pivotable brush 108 is selectively pivotable between a first position 160 (e.g., a stowed position) and a second position 162 (e.g., a use position). As shown in FIGS. 1 and 5, when the pivotable brush 108 is in the first position 160, the rod 144 is generally parallel to the outer arm 134 of the floss holder 104. As illustrated in FIG. 2, the pivotable brush 108 is pivotable to a plurality of varying positions, each position making an angle 148 with respect to the outer arm 134. In the example embodiment and as seen in FIG. 2, the angle 148 is variable depending on how much the pivotable brush 108 is pivoted away from the arm 134. More specifically, in one suitable embodiment, the angle 148 is variable from greater than 0° to about 90°. However, it is understood that the angle 148 may extend beyond 90° (for example, between about 0° and about 180°) in some embodiments without departing from the scope of the disclosure. Moreover, it is understood that the pivotable brush 108 may be angled in relation to any portions of the dental cleaning tool 100 without departing from some aspects of this disclosure.

The pivotable brush 108 may extend from any portion of the outer arm 134. In the illustrated embodiment, the pivotable brush 108 extends from the distal portion 140 of the outer arm 134. In suitable embodiments, the pivotable brush 108 may be oriented in any manner without departing from some aspects of this invention.

Once the pivotable brush 108 is selectively pivoted to the second position 162, which can correspond to any angle 148 preferred by the user, the user can comfortably use the pivotable brush 108 to clean their teeth. In particular, the user can comfortably hold the handle 102 and position the pivotable brush 108 against various surfaces of their teeth without having to awkwardly position their hand in relation to their mouth or awkwardly position the dental cleaning tool 100 within their mouth. Additionally, the pivotable brush 108 enables the dental cleaning tool 100 to reach difficult locations in a user's mouth (i.e., the back of the user's mouth). Moreover, the dental cleaning tool 100 is configured such that the pivotable brush 108 can be positioned in a variety of positions without being obstructed by the floss holder 104 and vice-versa.

As best illustrated in FIG. 4, the rod 144 has a distal end 150 and a proximal end 152. A length 154 is measured between the distal end 150 and the proximal end 152. Suitably, the length 154 is between about 10 mm and about 15 mm. In the illustrated embodiment, for example, the length 154 is approximately 12 mm. Suitably, the rod 144 has a base 155 extending from the proximal end 152 and a sidewall 156 extending from the base 155 to the distal end 150. In the illustrated embodiment, the sidewall 156 tapers as it extends from the base 155 to the distal end 150. The smaller diameter of the sidewall 156 at the distal end 150 facilitates the distal end 150 being positioned in tight spaces for cleaning. In addition, the base 155 has a smaller width than sidewall 156.

With reference again to FIG. 2, the base 155 of the rod 144 defines a living hinge 157 formed integrally with the floss holder 104. The living hinge 157 enables the pivotable brush 108 to be manually pivoted between the first and second positions 160, 162. In the illustrated embodiment, the base 155 has a curved transition 164 to the arm 134. The living hinge 157 in combination with the curved transition 164 inhibits the rod 144 breaking near the attachment to the arm 134 when the rod 144 is pivoted about the living hinge 157. It is understood the rod 144 may have any suitable shape and size without departing from some aspects of this disclosure. It is understood that the pivotable brush 108 may include alternative pivoting components to enable the pivotable brush 108 to be pivoted between the first and second positions 160, 162, such as one or more non-integrally formed hinge components (e.g., such that the pivotable brush 108 is removably attached to the floss holder 104), without departing from at least some aspects of the disclosure.

The bristles 146 extend from the sidewall 156 for cleaning the user's teeth. The bristles 146 may be arranged in any suitable manner. In the illustrated embodiment, the bristles 146 are arranged in a plurality of bristle groups 158 spaced along the length of the rod 144 and spaced annularly around the circumference of the cylindrical sidewall 156. In other suitable embodiments, the bristles 146 may be continuous along the length and/or circumference of the rod 144 instead of being arranged in the spaced bristle groups 158. Additionally, in suitable embodiments, the bristles 146 may extend from only a portion of the rod 144, e.g., along only one side of the rod 144 or only at the distal end 150. In the illustrated embodiment, the bristle groups 158 are arranged in four rows extending along the length 154 of the rod 144 that are spaced annularly around the circumference of the cylindrical sidewall 156. It is understood that the bristles 146 can be grouped in any suitable manner or can be arranged randomly on the sidewall 156.

In suitable embodiments, the dental cleaning tool 100 may be formed in any suitable manner and of any suitable material. For example, the dental cleaning tool 100 may be formed from metal, wood, plastic, and/or combinations thereof. In one preferred embodiment, the dental cleaning tool 100 is molded or otherwise formed from a single piece of resilient synthetic material, such as, but not limited to, plastic or metal. In the illustrated embodiment, the handle 102, the floss holder 104, the toothpick 106, and the pivotable brush 108 are integrally formed. More specifically in the illustrated embodiment, the entire dental cleaning tool 100, except for the floss strands 142, is molded as a single piece from acceptable food grade plastic. In other embodiments, any of the handle 102, the floss holder 104, the toothpick 106, and the pivotable brush 108 may be separately formed and attached to the dental cleaning tool 100 during assembly.

The dental cleaning tools described herein include a pivotable brush that extends the dental cleaning tool and is selectively pivotable between a first, stowed position and a second, use position about a pivot point at the point of attachment to the dental cleaning tool. Accordingly, the dental cleaning tools described herein expand the portions of a mouth that users can comfortably reach and effectively clean using the dental cleaning tools. Further, the pivotable brush as described herein increases the range of possible second position(s) and corresponding angle(s) of the pivotable brush that are unobstructed by other portions of the dental cleaning tool.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions without departing from the scope of the invention, it is intended that all matter contained in the above description and shown in the accompanying drawings shall be interpreted as illustrative and not in a limiting sense.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A dental cleaning tool comprising:
a handle defining a longitudinal axis of the tool;
a floss holder having a base and two arms extending from the base in perpendicular relation to the longitudinal axis;
at least one strand of floss extending between the two arms; and
a pivotable brush attached to the floss holder, the pivotable brush comprising a rod and bristles disposed on the rod, the rod pivotably mounted to the floss holder between a first, stowed position and a second, use position.

2. The dental cleaning tool in accordance with claim 1, wherein the first position is parallel to a portion of the floss holder and the second position is angled relative to the portion of the floss holder.

3. The dental cleaning tool in accordance with claim 2, wherein the portion of the floss holder comprises one of the two arms.

4. The dental cleaning tool in accordance with claim 2, wherein, when the rod is pivoted to the second position, the rod makes an angle between 0° and 90° relative to the portion of the floss holder.

5. The dental cleaning tool in accordance with claim 2, wherein the rod is pivotable to a plurality of second positions at a respective plurality of angles relative to the portion of the floss holder.

6. The dental cleaning tool in accordance with claim 2, wherein, when the rod is pivoted to the first position, the rod is adjacent the portion of the floss holder.

7. The dental cleaning tool in accordance with claim 1, wherein the rod comprises a living hinge integrally formed with the floss holder.

8. The dental cleaning tool in accordance with claim 7, wherein the rod further comprises a base arranged adjacent the living hinge opposite the floss holder, and wherein the living hinge has a width less than a width of the base.

9. The dental cleaning tool in accordance with claim 1 further comprising a toothpick extending from an end of the handle opposite the floss holder.

10. The dental cleaning tool in accordance with claim 9, wherein the floss holder, handle, and toothpick are formed as a single piece.

11. The dental cleaning tool in accordance with claim 10, wherein the pivotable brush is integrally formed as a single piece with the floss holder, handle, and toothpick.

12. A dental cleaning tool comprising:
a handle defining a longitudinal axis of the tool;
a floss holder for holding a plurality of floss strands;
a pivotable brush attached to the floss holder, the pivotable brush comprising a rod and bristles extending from the rod, the rod pivotably mounted to the floss holder; and
a toothpick having a pointed tip, the toothpick being spaced from the floss holder such that the handle is disposed between the toothpick and the floss holder.

13. The dental cleaning tool in accordance with claim 12, wherein the rod is selectively pivotable between a first, stowed position parallel to a portion of the floss holder and a second, use position angled relative to the portion of the floss holder.

14. The dental cleaning tool in accordance with claim 13, wherein, when the rod is pivoted to the second position, the rod makes an angle between 0° and 90° relative to the floss holder.

15. The dental cleaning tool in accordance with claim 13, wherein the rod is pivotable to a plurality of second positions at a respective plurality of angles relative to the portion of the floss holder.

16. The dental cleaning tool in accordance with claim 12, wherein the floss holder comprises at least one arm, the pivotable brush pivotably mounted to the at least one arm.

17. The dental cleaning tool in accordance with claim 16, wherein, when the rod is pivoted to the first position, the rod is adjacent the at least one arm.

18. The dental cleaning tool in accordance with claim 12, wherein the rod comprises a living hinge integrally formed with the floss holder.

19. A method of using a dental cleaning tool, the dental cleaning tool including a handle, a floss holder for holding a plurality of floss strands, a pivotable brush attached to the floss holder, wherein the pivotable brush includes a rod and bristles extending from the rod, the rod pivotably mounted to the floss holder, and a toothpick having a pointed tip, the method comprising:
selectively pivoting the pivotable brush between a first, stowed position parallel to a portion of the floss holder and a second, use position angled relative to the portion of the floss holder; and
using the pivotable brush to brush at least one tooth while the pivotable brush is in one of the first position and the second position.

20. The method of using a dental cleaning tool in according with claim 19, wherein selectively pivoting the pivotable brush between the first position and the second position comprises selectively pivoting the pivotable brush between the first position and the second position in which the rod makes an angle between 0° and 90° relative to the floss holder.
